(19) United States
(12) Patent Application Publication
(10) Pub. No.: US 2018/0267982 A1
(43) Pub. Date: Sep. 20, 2018

(54) SYSTEM AND METHOD OF DISCOVERING PERSONS OR OBJECTS OF INTEREST

(71) Applicant: Project Legacy Pty. Ltd., Kent Town, South Australia (AU)

(72) Inventor: James Edward HURST, North Adelaide (AU)

(21) Appl. No.: 15/761,039

(22) PCT Filed: Sep. 16, 2016
(86) PCT No.: PCT/AU2016/000324

§ 371 Date: Mar. 16, 2018

(30) Foreign Application Priority Data
Sep. 17, 2015 (AU) 2015903802
Mar. 15, 2016 (AU) 2016900969

(51) Int. Cl. G06F 17/30; G06T 19/00

(52) U.S. Cl. CPC G06F 17/3087; G06F 17/30241; G06F 17/30268; G06F 3/04847; G06F 17/30554; G06T 19/003; G06F 17/30867

(57) ABSTRACT

A computer implemented system enabling the discovery of information pertaining to a first user, the system including a user interface for use by first and second users, an image, a mapping application, wherein the user interface enables a first user to anchor information to the image for discovery by one or more second users, and wherein the user interface enables the one or more second users to search the image by use of the mapping application in order to discover anchored information pertaining to the first user.

### FIELD OF THE INVENTION

The present invention relates to a system and method of discovering persons of interest, such as, but not limited to, persons currently or previously residing at specific locations, past and present members of clubs, societies or educational institutions or persons associated with an event or an object.

### BACKGROUND OF THE INVENTION

There currently exists applications for searching and locating people by computer, for example, social or professional networking sites such as Facebook and Linkedin. However the effective use of such applications requires a searcher who is attempting to locate a particular person to have relatively accurate details including current name and/or address details of the person they seek to locate. This presents difficulties in locating people in situations where people change their names, either through marriage or other circumstances, move residence or when people have common names. Such difficulties make locating a person problematic and even sometimes impossible. Similar drawbacks exist with conventional telephone or address directories which rely on the searcher having accurate and current name and/or address details of the person of interest.

In addition, conventional methods and applications for locating persons of interest also make searching for people difficult, if not impossible, due to the vast volume of information captured and available on data communication networks such as the internet. Text based searching with the use of applications such as Google, often returns many results that are not relevant to the person of particular interest to the searcher.

A further disadvantage associated with conventional methods and applications for locating persons of interest is that the searcher is often required to filter a vast amount of information available on the internet which requires the searcher to enter specific textual search criteria in searching tools which often yields incorrect results due to the entry of inappropriate or generic/vague search terms. Accordingly it is difficult, if not impossible, to locate persons of interest associated with, for example, a particular event in time.

Presently, if a person seeks to locate information about another person associated with a past event, for example, one or more members attending a particular educational institution between a certain date-range, reliance must usually be placed upon the particular educational institution to publish, or otherwise make available, details about the institution, such as enrollment records. Often this information is not published by various groups and as a result, locating persons and/or details associated with particular events or places of interest in time remains difficult and at times impossible.

In addition to various groups not publishing or making information available, privacy issues also make it increasingly difficult to access information regarding persons of interest. In this regard, proprietary contact arrangements, for example, “In-mail” adopted within the professional networking site Linkedin, are increasingly used to protect the privacy of those registered with the Linked In networking service.

Further, in circumstances where a group such as a social club or an educational institution seeks to publish and/or update information on a data communications network such as the internet, expert skills and knowledge in constructing and updating websites is required which typically involves the assistance of external web-design experts.

Various websites, for example, eBay, e-commerce websites, Gumtree, or online classifieds advertisement websites, are available that allow users to advertise for sale and/or locate various objects of interest, for example, spare parts, accessories or items associated with an automobile, computer or any object of interest. Such websites can often be difficult to use since objects for sale can only be identified by the use of specific search terms that are generally selected by the seller which may not necessarily correlate with the term used by the person seeking to purchase an object of interest. Accordingly, potential sales and purchase opportunities are often lost due to the difficulty associated with sellers and potential purchasers failing to use consistent search terms.

Objects of interest may also be located through the use of search engines such as Google wherein a person seeking to purchase an object of interest enters a relevant search term or keyword. This method of locating objects of interest has the same problems associated with searching websites such as eBay and Gumtree as previously described, which require the entry of text based search terms. Further difficulties arise due to the obscuring of valid and relevant search results arising from paid advertising. In this regard it will be appreciated that as a result of paid advertising, a keyword search often yields or identifies results that are irrelevant or of less relevance as compared with results for which no payment has been made to increase the prominence of the search result. As a result, potential purchasers often find it difficult to locate objects of interest without scrolling through many prominent but irrelevant search results that are presented to the user according to the entered search terms.

The present invention is intended to address at least some of the above disadvantages associated with conventional methods of discovering persons or objects of interest.

The reference to any prior art in this specification is not, and should not be taken as, an acknowledgement or any suggestion, that the prior art forms part of the common general knowledge at the priority date of the claims herein.

### SUMMARY OF THE INVENTION

### System of the Invention

In one aspect, the present invention provides a computer implemented search system for information pertaining to a first user, the system including: a first user interface for use by first users; an image; and a mapping application; wherein the first user interface enables a first user to anchor information to the image for discovery by one or more second users; and wherein a second user interface enables one or more second users to search the image by use of the mapping application to discover anchored information pertaining to one or more first users.

In another aspect, the present invention provides a computer implemented search system for persons of interest, the system including a first user interface, a coordinate system, one or more oceans of information, and a mapping application, wherein the first user interface enables one or more first users electing to be discoverable to anchor information to the one or more oceans, and wherein a second user interface enables one or more second users to trawl one or more oceans of information associated with the coordinate system by use of the mapping application to discover information pertaining to one or more first users anchored to the one or more oceans.

In another aspect, the present invention provides a computer implemented search system for objects associated with persons of interest by a user, the system including: a first user interface; an image associated with one or more objects; and a mapping application; wherein the first user interface enables a first user electing to be discoverable to anchor information to the image; and wherein a second user interface enables a second user to search the image by use of the mapping application to discover information pertaining to the first user anchored to the image.

Skilled readers will appreciate that first and second users may be provided with different user interfaces for the separate tasks of anchoring information and subsequently searching for that information but in embodiments, it is preferable that the first and second user interfaces are implemented as a single user interface operable by both first and second users in respect of their respective tasks.

It will also be appreciated that use of a visual image either alone, or in combination with text based criteria, substantially improves the efficiency of searching for people or objects of interest and in some instances, will enable a search to successfully locate a person or object that could otherwise not be located due to insufficient available information regarding the person or object of interest at the time of conducting the search.

Conducting a search with an image forming the basis of restriction criteria regarding reported search results enables users to commence searching without any knowledge of the textual terms that are otherwise required to effect the same restriction to the search results.

Preferably, the first user interface enables first users to record additional information relevant to the anchoring of first users information to the image. The additional information may include dates, geographic locations, bibliographical information or any other information relevant to the location of the image selected by the first user to anchor identifying information pertaining to the first user.

### Computer Implemented System and User Interface

In an embodiment, a first user desiring to be discovered, anchors their information to the one or more oceans by the use of a virtual buoy.

In an embodiment, each virtual buoy has one or more attributes that allow filters, or search criteria, to be applied or entered by a second user during the trawling process. Such attributes may include, but are not limited to, dates, geographic locations and events or places of interest. Accordingly, when a second user is trawling for information, the second user may select a particular ocean to trawl and may enter one or more search criteria to be applied to the various attributes.

In an embodiment, the one or more oceans of information may be made visible by a first user, or may be hidden by a first user, from one or more second users accessing the system.

In an embodiment, the mapping application allows a user to trawl one or more oceans of information in which the user is able to use an electronic input device and cursor to cast, or drag, a virtual net over a defined geographical area to thereby limit search results to only the selected area.

In a further aspect, the present invention provides a computer implemented search for objects associated with persons of interest by a user, the system including a first user interface, an image of one or more objects, and a mapping application, wherein the first user interface enables a first user electing their object to be discoverable to anchor information to an object in the image, and wherein a second user interface enables a second user to search the image by use of the mapping application to discover information pertaining to the first user anchored to one or more objects in the image.

In an embodiment, a first user desiring an object to be discovered may anchor their information to an object in the image by the use of a virtual buoy.

In an embodiment, each virtual buoy has one or more attributes that allow filters, or search criteria, to be applied or entered by a second user during the searching process. Such attributes may include, but are not limited to, dates, geographic locations and travel distances to the location of the object. Accordingly, when a second user is searching for information, the second user may select a particular image to search and enter one or more search criteria to be applied to the various attributes.

In an embodiment, the mapping application allows the second user to use an electronic input device to position a cursor over a specific location on the image and view information anchored to that specific location by a first user.

In an embodiment, the mapping application allows a user to search by “trawling” in which the user is able to use their cursor and an electronic input device to cast a virtual net over an area of the image in order to limit search results to only the selected area.

The system according to aspects of the invention may be a publicly accessible system. Alternatively, the system of the invention may be a private system requiring authentication of first and/or second users to access and use the system.

The system may be computer-implemented system which users may access via a data communications network, such as the internet, or the system may be an application associated with a particular device.

The system may be a separate or stand-alone application that provides all of the functional features or elements of the system, or alternatively, the system may be embedded within one or more external (third party) systems or may itself offer additional functionality to an external (third party) application. Typical third party applications that are envisaged as being particularly suited for use in the system of the present invention are mapping applications such as Google or Bing maps, and social/professional networking sites such as Facebook or Linkedin.

The system of the invention according to any embodiment may be a single application or alternatively, may be a distributed application wherein separate applications are executed on separate computer processors to implement one or more features separately.

The user interface may be any conventional interface system that operates on a number of electronic devices including, but not limited to, a personal computer, laptop, mobile phone or iPad, and one that allows a user to interact with and use the system of the invention. The user interface may also allow authentication of a user's details by requiring the user to enter, for example, a unique username and password in order to access the system.

Authentication may be required in situations in which a user seeks to update information, hide information, make information visible to one or more other users and/or anchor information to the coordinate system. Alternatively, authentication may be required when users seek to access private “oceans” of information with restricted access. Of course, authentication may not always be required, particularly in situations where a user seeks to search (or “trawl”) oceans of information that are visible and publicly accessible.

Discovery through Anchoring and Trawling

Information may be anchored by a first user seeking to make themselves, or an object in their possession, “discoverable” by means of one or more virtual buoys which are discrete information records associated with the first user. Each buoy may contain the anchoring position of the information on the coordinate system and provide the spatial context for the information and associate the data record with a location. For example, a person that attended a particular college at a certain point in time may anchor their information to the geographical location of that college thereby making themselves “discoverable” to other users of the system.

The information anchored by the first user making themselves, or an object in their possession, available to be discovered may include details such as their name, their contact details such as a telephone number, mobile phone number or current address. The contact details may also be an email address or a Skype address or may be a link (for example a URL, path or pointer) to the first user's profile on a social or professional networking site such as Facebook or Linkedin. Ultimately, the contact details, or link, provide sufficient information to facilitate contact between two parties (i.e., the first and second users).

In an embodiment, the security features associated with a third party social networking website such as Facebook or Linkedin will provide any required level of security and privacy to users.

Additionally, each virtual buoy (or information record) may include one or more attributes, such as, but not limited to, names and dates, that assist in the trawling (or searching) process. It will be appreciated that the one or more attributes should make searching easier since the user is able to focus the trawl (or search) and thereby limit the amount of information that is discovered as a result of the trawl (or search).

In an embodiment, the attributes associated with each virtual information buoy are determined by the ocean in which the virtual buoy is anchored. For example, an ocean containing information regarding people would have different attributes as compared with an ocean containing information in respect of places of interest. In addition to names and dates, other possible attributes that assist trawling for information associated with persons of interest may include keywords, geographic location or details pertaining to an event.

Typically, one or more virtual information buoys will be anchored in a defined ocean of information, wherein each virtual buoy is linked to records of a person of interest and is therefore “discoverable” to a user trawling (or searching) for information.

Desirably, the system of the invention is able to be used by persons of limited computer skills such that a second user is able to easily “trawl” for information or a first user is able to simply drop an “anchor” of information at any point on a coordinate system.

### The Geographic Coordinate System and Mapping Application

In an embodiment, the coordinate system is a geographic coordinate system and provides a reference upon which “virtual buoys” may be anchored within one or more defined oceans. The geographic coordinate system may have one, two or multiple dimensions depending upon the application. A typical example of a possible geographic coordinate system is the global spherical (latitudinal/longitudinal) coordinate system used to specify the position of a point on the earth's surface. Other geographic coordinate systems include map projection models that are used to project maps of the earth's spherical surface onto a two-dimensional Cartesian (X/Y) coordinate plane.

A mapping application may be associated with the image or the geographic coordinate system that may overlay an image, a geographic map or other visual or audio content associated with the geographic coordinate system thereby allowing a second user to navigate the geographic coordinate system to trawl or a first user anchor information with respect to one or more oceans of information.

Information may be anchored by a first user onto one or more oceans associated with a geographic coordinate system using a mapping application such as, but not limited to, Google Maps, Apple maps or Bing maps.

The mapping application may also provide functionality that enables a second user to trawl (or search by moving their electronic input device and cursor to thereby drag a virtual net over a defined geographic area) and locate a point of interest on the geographic coordinate system at which point information may have been anchored by a first user. In its broadest form, mapping applications may also include applications and devices such as media players, image viewers and televisions.

The one or more Oceans of Information

The term “ocean” in the context of the present specification means the logical or physical separation of data into any desired categories. As an example, such categories may include, but are not limited to, information relating to certain individuals or different groups, or information relating to certain events associated with a particular date range. Of course, the number of oceans and their purpose will depend upon the nature of the information through which a first and second user seek to contact each other.

It will be appreciated that the physical separation of data into one or more oceans assists maintaining a logical separation of data that enables a single system to be used for a variety of purposes and also allows the one system to cater for different user groups and also assists to avoid overcrowding of data.

An “ocean” of information may be publicly accessible or may be private and therefore accessible to only a select group of users who have been provided authorized access to that particular ocean of information. In this regard, various groups may be able to offer information to a select group of users or a single user may be able to make themselves discoverable to only a select group of users. This is preferably achieved by enabling a first user who anchors their information to “turn on” (make visible) or “turn off” (hide) one or more oceans completely or partially. For example, a first user may prefer to make their contact details visible to only a select group of people and so may make the ocean partially visible to a select group of second users.

It will be appreciated that embodiments of the invention may use one or more oceans which a second user may be able to “turn on” or “turn off” as required in order to access and view different layers of information.

### Representation of an Image and Mapping Application

In an embodiment, images include, but are not limited to, objects such as an automobile, a furniture item, a house, or a computer.

The image may be any type of image and includes, but is not limited to, a graphical image, a wire-frame image, a 3D virtual model or a photograph.

In an embodiment, the image is overlaid with a coordinate system that enables the user, through the use of the mapping application associated with the image, to identify and/or select an object, or part of an object, located in the image. In an embodiment, the coordinate system is a grid coordinate system and provides a reference upon which “virtual buoys” may be anchored within the image. The grid coordinate system may have one, two or multiple dimensions depending on the application.

### The Method of the Invention

In another aspect, the present invention provides a computer implemented searching method for information pertaining to a first user by one or more second users, the method including: the first user accessing a computer-implemented system through a first user interface, wherein the system includes an image and a mapping application; the first user navigating the image using the mapping application associated with the image; and the first user anchoring information to the image that enables the discovery of information pertaining to the first user by the one or more second users.

In another aspect, the present invention provides a computer-implemented searching method for discovering a first user by one or more second users, the method including the steps of: the first user accessing a computer-implemented system through a first user interface, wherein the system includes a coordinate system, one or more oceans of information and a mapping application; and the first user navigating the coordinate system using the mapping application associated with the coordinate system; and the first user anchoring information to one or more oceans of information using the mapping application associated with the coordinate system, wherein the information enables the discovery of the first user by the one or more second users.

In another aspect, the present invention provides a computer-implemented searching method discovering objects associated with a first user, the method including the steps of: a first user accessing a computer-implemented system through a user interface, wherein the system includes an image associated with one or more objects and a mapping application; and the first user navigating the image using the mapping application; and the first user anchoring information to the image using the mapping application, wherein the information enables the discovery of objects associated with the first user by the one or more second users.

In another aspect, the present invention provides a computer implemented searching method enabling one or more second users to discover information pertaining to a first user, the method including: the one or more second users accessing a computer-implemented system through a user interface, wherein the system includes an image and a mapping application; and the one or more second users searching for information using the mapping application to locate and view one or more virtual buoys of information anchored to the image.

In another aspect, the present invention provides a computer implemented searching method enabling one or more second users to discover a first user, the method including the steps of: the one or more second users accessing a computer-implemented system through a user interface, wherein the system includes a coordinate system, one or more oceans of information and a mapping application; and the one or more second users trawling for information using the mapping application associated with the coordinate system to locate and view one or more virtual buoys of information anchored within the one or more oceans.

In another aspect, the present invention provides a method enabling one or more second users to discover one or more objects associated with a first user, the method including: the one or more second users accessing a computer-implemented system through a user interface, wherein the system includes an image associated with the one more objects and a mapping application; and the one or more second users searching the image using the mapping application to locate and view one or more virtual buoys of information anchored to the image.

### User Anchoring of Information

In embodiments where more than one ocean of data exists, the first user may also select one or more oceans of interest within which to navigate and anchor one or more virtual buoys.

In an embodiment, the first user may invoke a function to drop an anchor at a position of interest. This may involve clicking, tapping or invoking a menu function with an electronic input device. The first user may also populate fields with attributes that will be associated with a virtual buoy of information that will allow the user to be discovered according to search criteria. It will be appreciated that in certain embodiments, the computer system may be able to automatically populate various fields with attributes, for example, the first user's name associated with their log-in details.

The first user may also provide a link or some pointer to a third party website such as their social or professional networking profile such as Facebook or Linkedin.

### User Trawling to Discover a Person of Interest

In embodiments where more than one ocean of data exists, the second user may also select one or more oceans of interest within which to conduct a trawl (or search).

In situations where large amounts of information exist, a second user may also enter one or more search criteria restricting their search to attributes associated with a first user to limit the trawl area. For example, a second user may limit the trawl area by keyword, geographic location and/or date range.

Upon completing a trawl, the second user may be presented with one or more results (virtual buoys) that match the entered search criteria. At this point, the second user may be able to inspect the virtual buoys and identify contact information if attributes such as a name and a telephone number are associated with the virtual buoy. Alternatively, if a virtual buoy that matches the trawl criteria contains a link to a social website such as Facebook, the second user may select or otherwise use the link to be transferred to the website of the discovered first user.

Embodiments of the invention will now be described in further detail with reference to the accompanying figures.

### BRIEF DESCRIPTION OF THE FIGURES

FIG. 1 provides a conceptual illustration of the system in accordance with an embodiment of the invention identifying the system components and how the components relate to one another to allow a user to either anchor, or trawl for, information to discover a person of interest;

FIG. 2 provides a conceptual illustration detailing the association between the mapping application and a geographic coordinate system and also illustrating the anchoring of a user's personal information to an ocean in accordance with an embodiment of the invention;

FIG. 3 illustrates a table of possible attributes that may be associated with an information buoy with a description/purpose of each attribute in addition to an example of each possible attribute;

FIG. 4 provides a conceptual illustration of how attributes are able to be linked to an information buoy to provide more information associated with a person of interest in order to facilitate interaction between two parties;

FIG. 5 provides an example of a user interface in accordance with an embodiment of the invention detailing, in particular, an embedded mapping application, various anchored information, the contact details of a discovered person of interest and the trawl filter adopted by a user to limit and/or focus the trawl;

FIG. 6 is a block diagram of how a system may be used in accordance with an embodiment of the invention enabling a user to make themselves discoverable;

FIG. 7 is a block diagram of how a system may be used in accordance with an embodiment of the invention enabling a user to discover a person of interest;

FIG. 8 is provides an example of a user interface that a user encounters upon attempting to access the system in accordance with an embodiment of the invention; and

FIG. 9 provides an example of a user interface showing the results of a trawl in accordance with an embodiment of the invention.

FIG. 10 provides an example of a user interface showing the results of a search conducted on an image of an automobile in accordance with an embodiment of the invention; and

FIG. 11 provides an example of a user interface showing the results of a search conducted on a representation of an image of an automobile showing in particular the contact details of a discovered person of interest in accordance with an embodiment of the invention.

### DETAILED DESCRIPTION OF EMBODIMENT(S) OF THE INVENTION

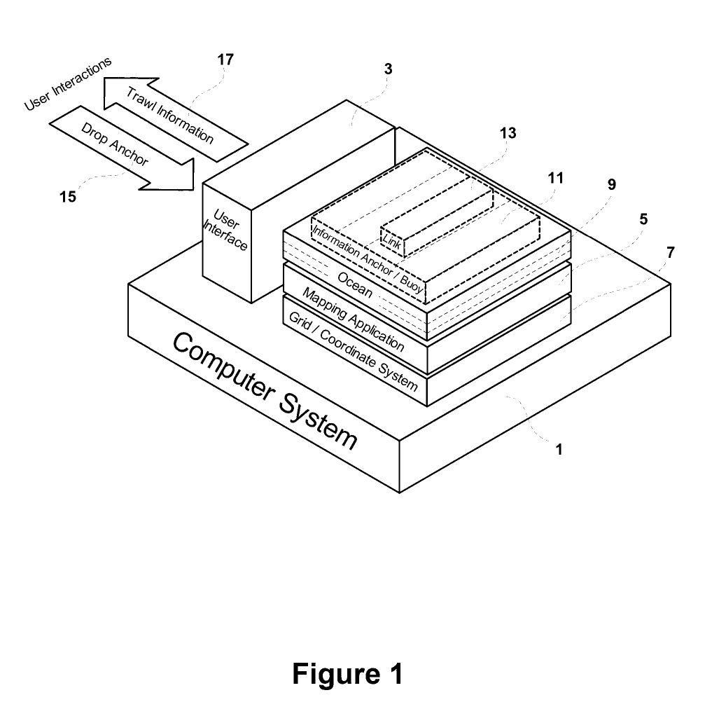

A system according to an embodiment of the invention is illustrated in FIG. 1 wherein the system components and their interrelationship is illustrated. In this embodiment, a computer-implemented system (1) that may be any device including, but not limited to, a personal computer, laptop, mobile phone or iPad, is accessed through user interface (3) and includes mapping application (5) associated with geographic coordinate (grid/coordinate) system (7), Mapping application (5), for example Google Maps, allows a user to trawl one or more oceans (9) of information in order navigate geographic coordinate system (7) and locate one or more information buoys (11) associated with a person of interest and anchored to one or more oceans (9). FIG. 1 also shows that one or more buoys (11) is/are associated with one or more links (13) to any third party website including professional or social networking sites such as, but not limited to, Facebook and/or Linkedin.

The illustration of FIG. 1 also depicts an inwardly facing arrow (15) that demonstrates the anchoring of information by a user onto system (1) when the user seeks to make themselves discoverable to other users accessing the system. FIG. 1 also depicts an outwardly facing arrow (17) that demonstrates trawling by a user when the user seeks to discover a person of interest who may have made themselves discoverable to the system (1).

Any first time user seeking to enter discoverable personal information must initially register on the system (1) and create a profile by providing, as a minimum, a user name and password. In order to re-enter the system (1), the user will necessarily undergo an authentication process and re-enter their username and password thereby ensuring a secure system that only allows a user's personal details and/or discoverable information to be updated/altered after entry of the correct authentication details. Of course, if a user only seeks to search for information regarding persons of interest, it may not be necessary to create a profile and the user may access the system (1) in the absence of any authentication step.

The system (1) shown in FIG. 1 may be a computer system, one or more computer applications, or any device with a user interface that allows a user to access the system (1). The system (1) may be a stand-alone system that provides all the necessary functionality to allow a user to access, trawl and anchor information. In other embodiments, the system (1) may be embedded within another third party system, such as Google Maps, that provides either all, or at least some, of the features/applications to allow a user to trawl and anchor information. Alternatively, the system (1) may provide additional functionality to an existing third party application such that it enables a user to trawl and anchor information. The system (1) may be publicly accessible through the internet, or it may be a private program with restricted access.

It will be appreciated that the system and method of the present invention addresses the difficulty that confront many people when attempting to locate past friends, acquaintances and relatives using data communication networks such as the internet or conventional search tools such as the telephone directory. Searching for persons of interest using current techniques is often tedious and can often yield either no results or a vast amount of results that due to the large volume ceases to be useful or provide any assistance in locating persons of interest.

### People at Locations

A system and method according to an embodiment of the invention enables persons of interest to be searched geographically. Accordingly, any user that seeks to locate one or more persons of interest may trawl (or search) an image of geographic area in which they know a person was once associated with that geographic location. For example, persons may be associated with a particular location or an event at that location. If the search (trawl) is successful, the user is preferably able to follow a link to a social or professional networking site of the discovered person of interest that will facilitate contact between the user and the person of interest.

The following description relates to a specific embodiment of the system and method of the invention. However, it will be appreciated by skilled readers that the invention is not limited to the specific features of the described system and method.

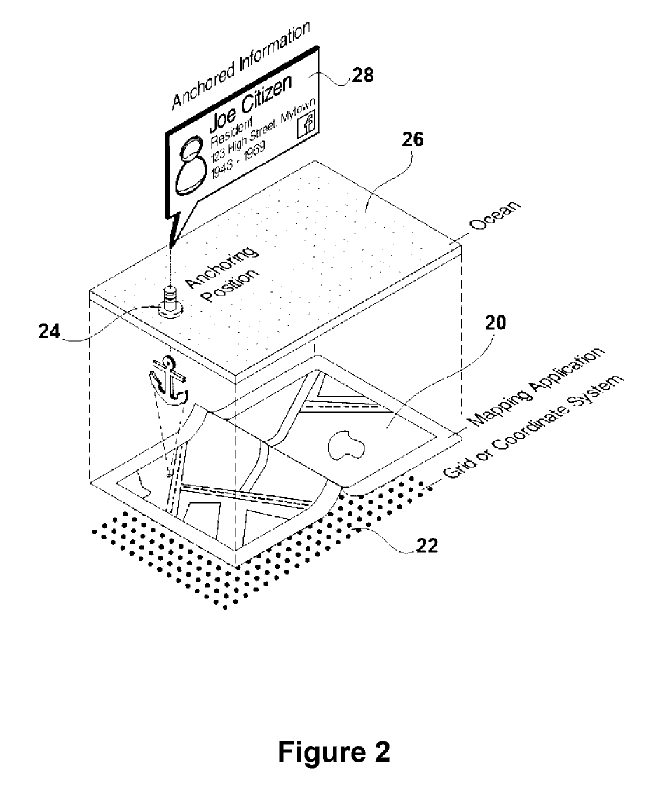

In the embodiment shown in FIG. 2, the system is constructed as a stand-alone computer system that embeds a mapping application (20) such as Google maps. Google maps is particularly suited for use in the described embodiment of system of the present invention as it will be appreciated that this application operates on a variety of platforms and has an extensive application programming interface (API). It is the API that allows Google maps to be embedded within other applications and also allows other features/applications to be overlaid on the maps. Whilst Google Maps is a preferred mapping application, other mapping applications such as Apple or Bing maps may be used with the system and method of the present invention.

The mapping application (20) provides the functionality that allows a user to locate the point on geographic coordinate system (22) where one or more information buoys (24) are able to be anchored to one or more oceans (26) of information (28). Additionally, the mapping application (20) also allows a user to locate the area upon which they intend to trawl (or search) for any information that has been anchored by other users. In other embodiments, a user is able to use mapping application (20) to search an image of an object, for example, a particular make (brand) and model of an automobile, in search for spare parts that may be offered for sale by another user.

In the embodiment shown in FIG. 2, the geographic coordinate system (22) uses the global spherical (latitudinal/longitudinal) coordinate system used to specify the position of a point on the earth's surface. It will appreciated that other coordinate systems may be suitable for use in the system of the present invention including map projection models that are typically used to project maps of the earth's spherical surface onto a two-dimensional Cartesian (X/Y) coordinate plane. Other coordinate systems that may be used within the system of the present invention may have one, two or multiple dimensions depending upon the application.

The system shown in FIG. 2 includes only one ocean (26) of “people at locations” that is publicly accessible. It will be appreciated that the ocean (26) forms a layer of data containing anchored information that overlays the geographic coordinate system (22). Whilst in some embodiments it may be possible to adopt a generic relational database, in preferred embodiments, a spatial database is adopted within which to store the ocean of information.

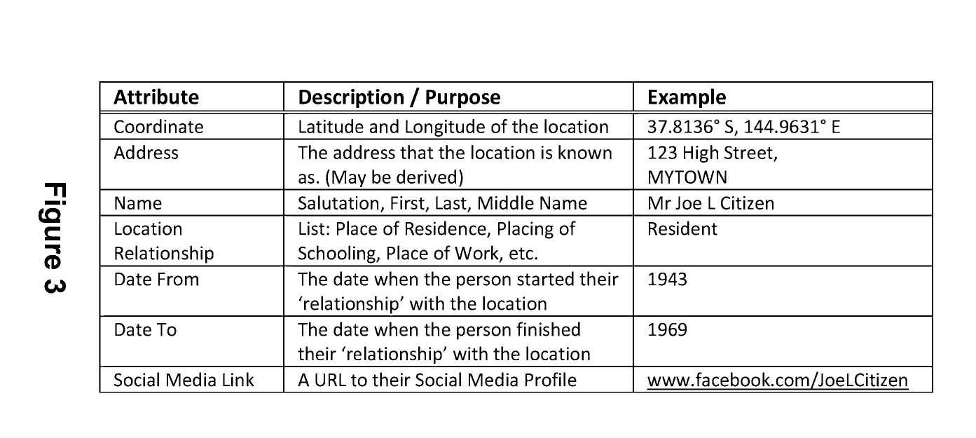

With further reference to FIG. 2, information buoy (24) represents an actual person of interest and the relation that that person has with the particular location. An example of the information associated with a particular buoy is shown in FIG. 3, in which each information buoy or record within the “people at locations” ocean (26) has attributes such as those shown in FIG. 3. In an embodiment, each anchored buoy is implemented as a row or record in a spatial database.

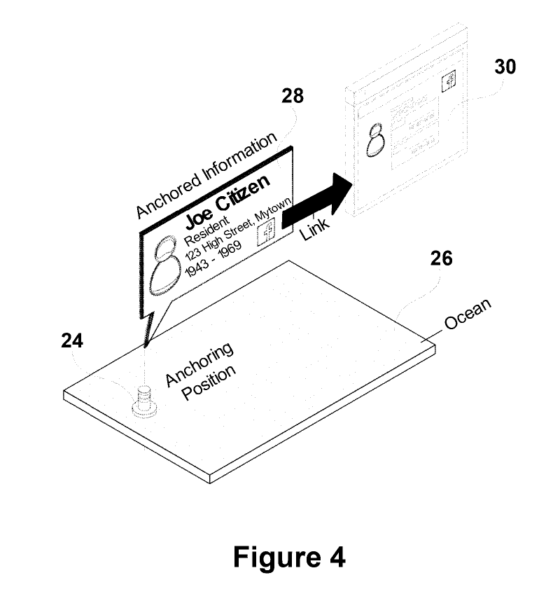

In the embodiment shown in FIG. 2, associated with the information (28) is a link (30) as shown in FIG. 4. The link (30) is implemented as a URL hyperlink to a social media profile and is one of the attributes captured in the information buoy (24) and as is listed in the table of FIG. 3.

People at Locations with User Interaction

The following section describes how a user may interact with a system according to an embodiment of the present invention in accordance with the “people at locations” embodiment.

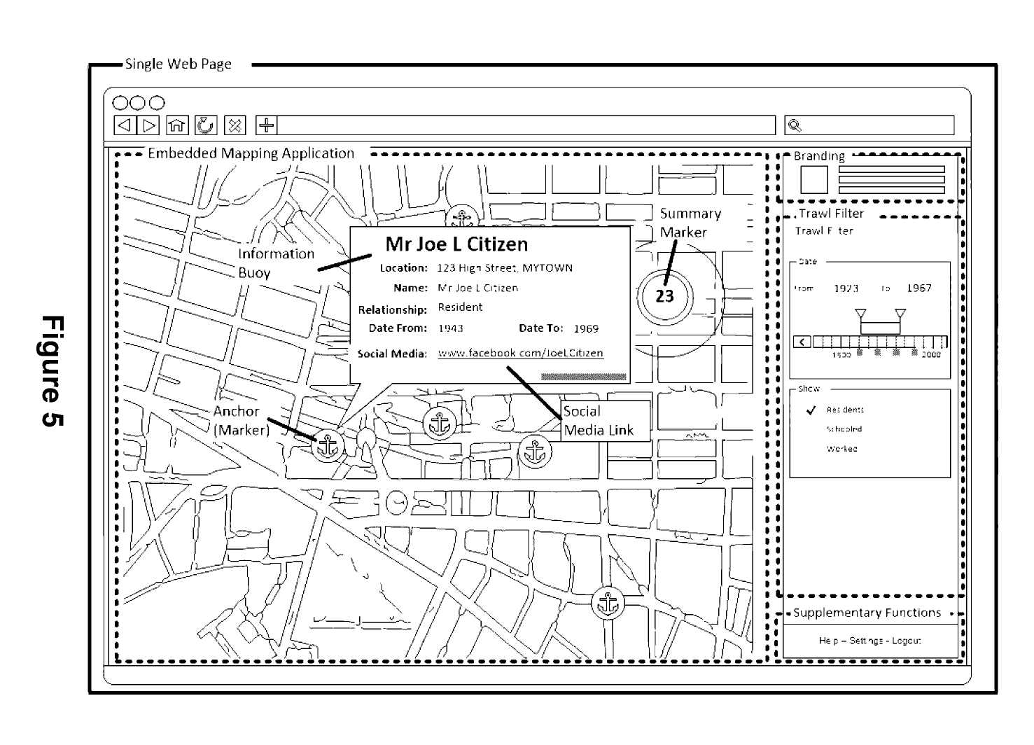

An embodiment of the system and method of the present invention allows a user to anchor and trawl information in the absence of any special skills. This may be achieved by the use of a single web page user interface that allows “anchoring” or “trawling” to be performed simultaneously. An example of an interface that may be used with the system and method of the present invention is shown in FIG. 5. It will be appreciated that the interface shown in FIG. 5 represents only one possible configuration and other interface configurations are possible to suit the particular embodiment and application.

Preferably, the user interface will support at least two user interactions which are “anchoring” and “trawling”. In other embodiments, the user interface may support a range of additional functions including, but not limited to:
Setting user preferences/user details
Obtaining/providing help and information
Entering user registration details
Logout/exit functions
Allowing a user to update a system and delete/remove anchors
Allow a user to report anchors that are considered inappropriate/inaccurate
Allow a user to obtain/set a new password

The system will also desirably have one or more security features such as CAPTCHA to prevent unwanted anchoring and saving of information by automated programs (i.e. non-human users).

Anchoring Information in which a User Desires to make themselves Discoverable

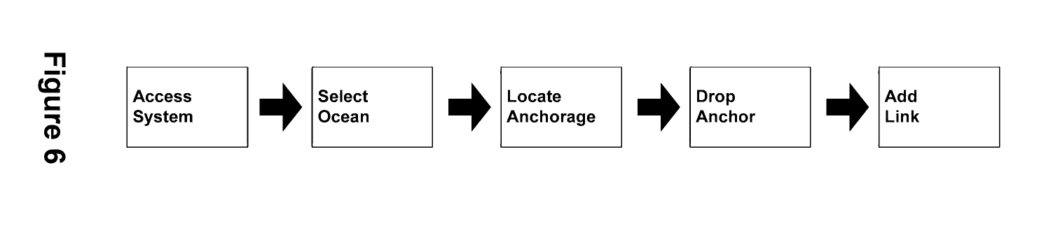

The steps involved in a user anchoring information onto a system in accordance with an embodiment of the invention is shown in the block diagram of FIG. 6.

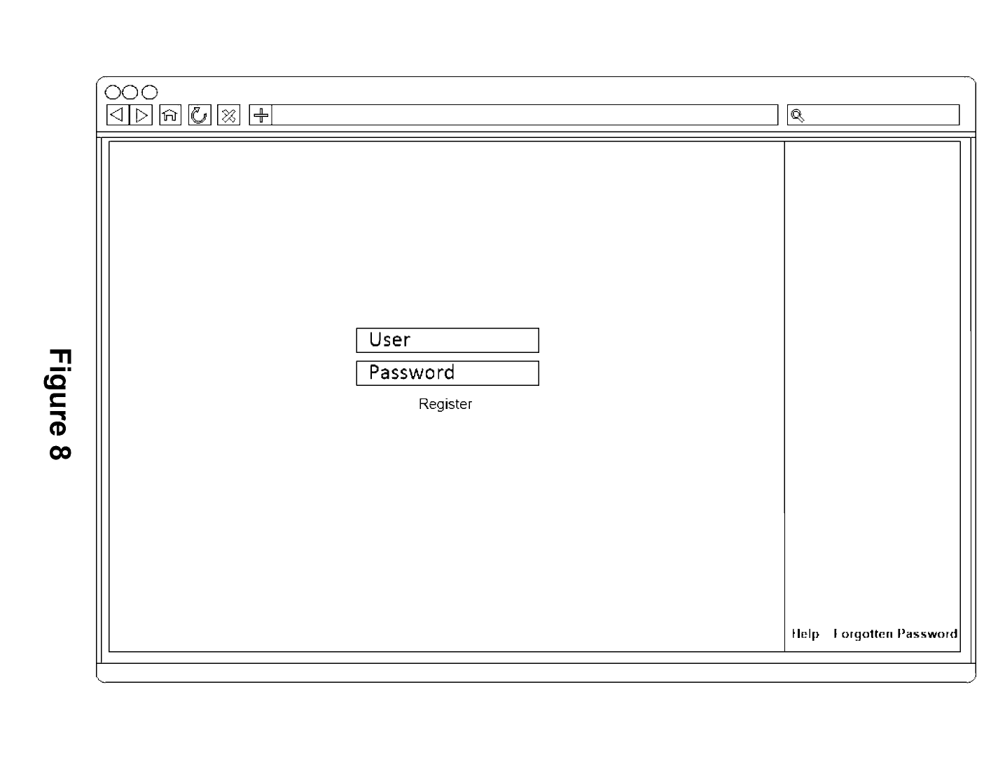

The first step involves accessing the system through a user interface associated with the system that is available across the internet. The user is able to access the system by launching a browser and entering a URL upon which the user is presented with a login page as shown in FIG. 8.

Authentication of the user is required and accordingly the user is prompted to enter their username and password. Upon providing the correct username and password details, the user is then directed to a system profile which may contain personal details of the user such as their name and any links to associated social media profiles which could be used to auto-populate the information buoys.

Once the user is directed to their system profile, the user will typically select an ocean of information within which they seek to anchor information. In this embodiment, as the only ocean is the “people at locations” ocean, the user does not need undertake an ocean selection step.

In order to anchor their personal information, the user navigates Google Maps by dragging their mouse pointer over the map in order to locate a position of interest (latitude/longitude coordinates), for example, of a former residence, to which their profile is to be anchored.

Once the location has been identified, the user may then “drop” an anchor by clicking their mouse on the desired location thereby anchoring an information buoy with their personal information at the location of interest. Preferably, the information buoy includes a URL link to their social media profile and the buoy is auto-populated upon the user “dropping” an anchor. Once the user saves the information buoy anchored to the ocean, the information buoy is available for discovery by other users.

The user may continue to “drop” further anchors or may choose to trawl for information in order to discover persons or interest or may choose to exit the system.

Trawling for Information in which a User Desires to Discover one or more Persons of Interest

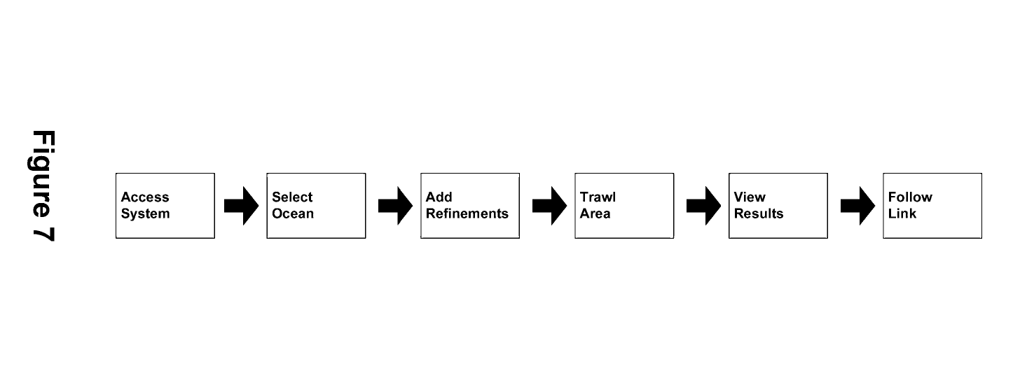

The steps involved in a user trawling for information within a system in accordance with an embodiment of the invention is shown in the block diagram of FIG. 7.

The first step involves accessing the system through a user interface associated with the system that is available across the internet. The user is able to access the system by launching a browser and entering a URL upon which the user is presented with a login page as shown in FIG. 8.

If authentication of the user is required, the user will be prompted to enter their username and password. Upon providing the correct username and password details, the user is then directed to the system profile which may contain personal details of the user such as their name and any links to associated social media profiles which could be used to auto-populate the information buoys.

Once the user is directed to their system profile, the user will typically need to select an ocean of information within which they seek to trawl for information. In this embodiment, as the only ocean is the “people at locations” ocean, the user does not need to undertake an ocean selection step.

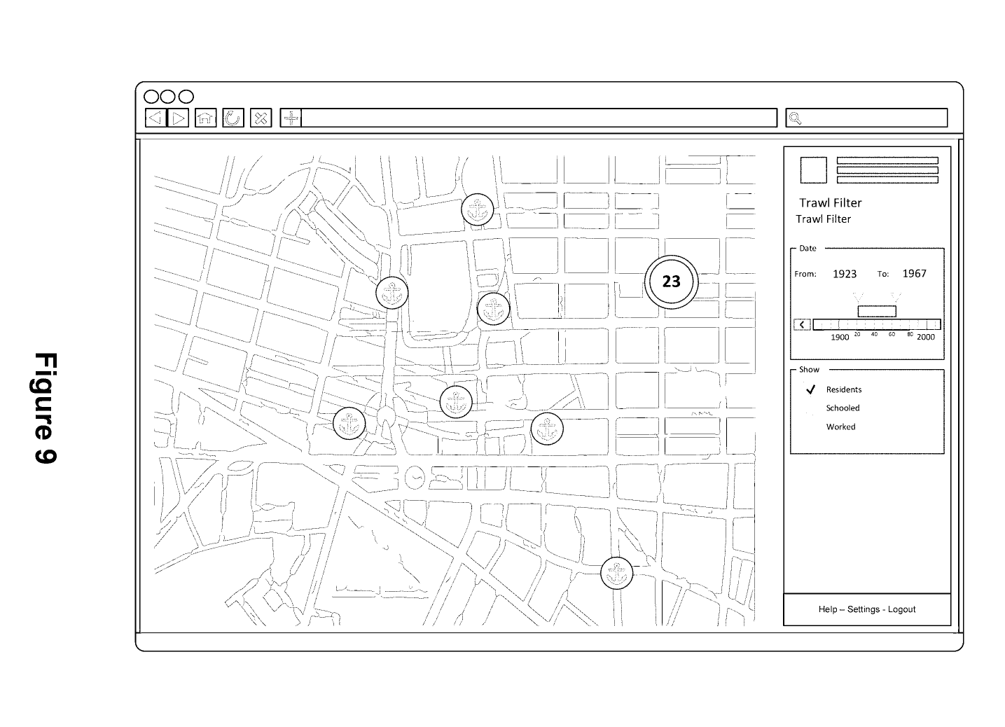

As a means of focusing or limiting the search results returned, a user may refine their search by entering search criteria such as a specific date range within a trawl filter located on the user interface. An example of such a trawl filter is shown in the interface shown in FIG. 9.

Once the desired ocean has been selected and search criteria have been entered in the trawl filter, the user trawls for information associated with persons of interest by navigating Google Maps and dragging their mouse pointer over the map to locate a position of interest (latitude/longitude coordinates), for example, a known former residence of a person of interest. As the user navigates the system, a search query is performed on the spatial database to identify any results/records in the trawl area that match the search or filtering criteria. These records/results are then overlaid on the map as shown in FIG. 9 which are visible to the user and which allow the user to make contact with the person of interest preferably through a link connected to the social media profile of the person of interest.

In the case where there are numerous results to display in a given area, a summary marker is shown at that particular location (for example, the summary marker (23) shown in FIG. 9), that indicates how many records exist at that location that match the entered search or filter criteria. The user may refine a search to further limit the results/records returned.

Once a person of interest has been identified, the user may continue to trawl for information to discover further persons or interest or may “drop” one or more anchors in order to make themselves discoverable or may choose to exit the system.

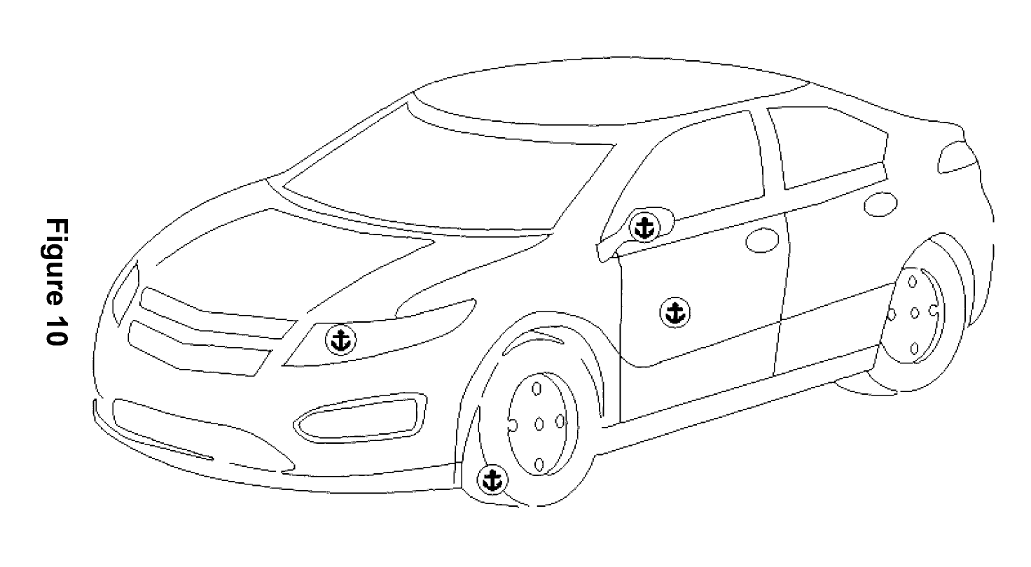

The system and method of the invention may also be used by a user to identify objects, or parts of objects, associated with a person of interest, for example, an automobile or any part of an automobile as shown in the embodiment of FIG. 10. As can be seen from FIG. 10, a number of anchors are overlaid on the image showing the user parts of the automobile which may be available for purchase.

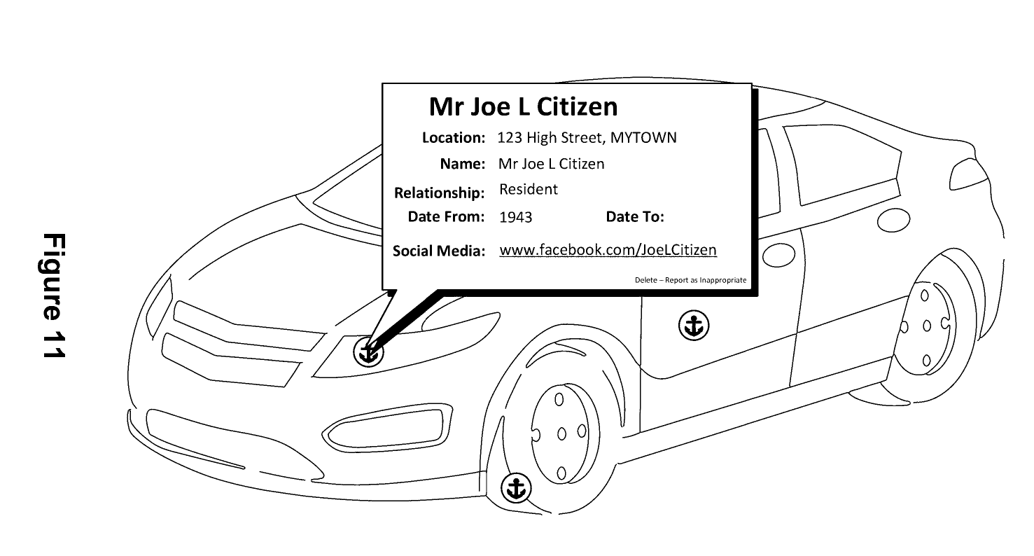

It will be appreciated that each anchor is associated with a buoy of information of one or more persons of interest in possession of that particular part of the automobile. For example and as is shown in FIG. 11, the contact details of the person of interest are revealed once a user positions their cursor over an anchor associated with the front headlight of the automobile. Accordingly, the person of interest that is associated with that specific automobile part and that has made themselves discoverable may be contacted by the user if the user is interested in purchasing, or otherwise acquiring, from the discovered person of interest, that specific part of the automobile.

Whilst FIGS. 10 and 11 are directed to identifying persons of interest in possession of spare parts of an automobile, other embodiments may be directed to identifying persons of interest having possession of, and/or interested in selling, objects including, but not limited to, motorbikes and motorbike parts and accessories, furniture items, clothing items and accessories or computer parts and accessories.

The image shown in FIGS. 10 and 11 is a two dimensional image of a generic automobile although it will be appreciated that in other embodiments the image may be a three dimensional image and may be able to be manipulated where the user is able to, for example, rotate the image in three dimensions and also zoom in and out as desired in order to clearly identify and focus upon specific sections of the object as represented in the image.

It will be appreciated that the system and method of the present invention is user friendly and thereby allows any user, even those users with a low level of computer skills, to make themselves discoverable through the use of the system and method of the present invention. The system and method also allows a plurality of users to access and use the system over, for example, a network or the internet and thereby provides a system that is not only easy to use, but is also widely accessible by any person seeking to use the system to identify persons of interest, or objects associated with persons of interest, and/or seeking to make themselves discoverable.

It will also be appreciated that the system and method of the invention allows ordinary users without any expertise in, or detailed knowledge of, various articles or parts, to view, and more easily locate parts of articles.

For example, a user may wish to locate a thermostat for their refrigerator. Whilst the user may not know the name, or part number, of the thermostat, the user would likely know the brand of their refrigerator. Accordingly, the system and method of the invention allows the user to view an image of their refrigerator, for example, a virtual three dimensional model which they can manipulate (i.e., rotate and zoom in), in order to identify the thermostat of interest in the context of the refrigerator. Once the appropriate thermostat has been identified, the user may obtain the contact details of another user who is in possession of the same thermostat part and who has anchored their information to the thermostat part on the three dimensional image.

Notably, in the above example, neither the ordinary person in possession of the thermostat, nor the ordinary user that is in need of the new thermostat, need to know the part number or even the name of the part. Accordingly, the thermostat part may be easily offered for sale and/or sourced in the absence of the users having to seek any additional expert or professional advice such as from a refrigeration salesperson or mechanic.

Throughout this specification and claims which follow, unless the context requires otherwise, the word “comprise”, and variations such as “comprises” and “comprising”, will be understood to imply the inclusion of a stated integer or step, or group of integers or steps, but not the exclusion of any other integer or step or group of integers or steps.

It will be appreciated by persons skilled in the relevant field of technology that numerous variations and/or modifications may be made to the invention as detailed in the embodiments without departing from the spirit or scope of the invention as broadly described. The present embodiments are therefore to be considered in all aspects as illustrative and not restrictive.

1. A computer implemented system enabling the discovery of personal contact information pertaining to a first user, the system including:
a user interface for use by first and second users;
a geographical image;
a mapping application;
wherein the user interface enables a first user to anchor their personal contact information and a first date or date range to the geographical image for discovery by one or more second users; and
wherein the user interface enables the one or more second users to enter a second date or date range of interest into a search field to search the geographical image using the mapping application thereby discovering anchored personal contact information pertaining to the first user when the second date or date range matches the first date or date range.

2. A computer implemented system according to claim 1 wherein the first user anchors their personal contact information to the geographic image by the use of a virtual buoy.

3. A computer implemented system according claim 1 wherein the virtual buoy is associated with one or more attributes.

4. A computer implemented system according to claim 1 wherein the attributes are selected from any one or more an address of a geographic location, an event or a place of interest.

5. A computer implemented system according to claim 1 wherein the geographic image is selected from any one of a graphical image, a wire-frame image, a 3D virtual model or a photograph.

6. A computer implemented system according to claim 1 wherein the geographic image is overlaid with a coordinate system.

7-14. (canceled)

15. A computer implemented method of enabling the discovery of information pertaining a first user by one or more second users, the method including:
the first user accessing a computer-implemented system through a user interface, wherein the system includes a geographic image and a mapping application;
the first user navigating the geographic image using the mapping application associated with the image; and
the first user anchoring their personal contact information and a first date or date range to the image that enables the discovery of the personal contact information pertaining to the first user by the one or more second users.

16. A computer-implemented method according to claim 15 wherein the first user anchors their personal contact information and a date or date range to the geographic image by the use of a virtual buoy.

17. A computer-implemented method according to claim 15 wherein the virtual buoy is associated with one or more attributes.

18. A computer-implemented method according to claim 15 wherein the attributes are selected from any one or more of an address of a geographic location, an event or a place of interest.

19. A computer-implemented method according to claim 15 wherein the geographic image is selected from any one of a graphical image, a wire-frame image, a 3D virtual model or a photograph.

20. A computer implemented method according to claim 15 wherein the image is overlaid with a coordinate system.

21. A computer-implemented method according claim 15 wherein the one or more virtual buoys anchored within the image by the first user include a link to a third party social or professional networking website.

22-30. (canceled)

31. A computer-implemented method enabling one or more second users to discover personal contact information pertaining to a first user, the method including:
the one or more second users accessing a computer-implemented system through a user interface, wherein the system includes a geographic image and a mapping application; and
the one or more second users entering a date or date range of interest into a search field and searching for personal contact information pertaining to the first user by the use of the mapping application to locate and view one or more virtual buoys of personal contact information anchored to the geographic image.

32. (canceled)
